(19) United States
(12) Patent Application Publication
(10) Pub. No.: US 2002/0015103 A1
(43) Pub. Date: Feb. 7, 2002

(54) System and method of capturing and processing digital images with depth channel

(76) Inventor: Zhimin Shi, Secaucus, NJ (US)

Correspondence Address: Jie Sha, Attorney-at-law, 195 North Harbor Drive, Suite 3504, Chicago, IL, 60601, US

(21) Appl. No.: 09/912,706

(22) Filed: Jul. 25, 2001

Related U.S. Application Data
(60) Provisional application No. 60/220,557, filed on Jul. 25, 2000.

(51) Int. Cl. H04N 5/232

(52) U.S. Cl. 348/348

(57) ABSTRACT

A method of capturing and processing a digital image with a depth channel comprises receiving reflective and deflective light beams from an object, sensing the received light beams to generate digital images with distance information, storing the digital images, including the depth channel, and analyzing and processing the digital images with the depth channel. The original two-dimensional digital image may be processed or recreated as quasi three-dimensional digital images through the adjustment of such depth channel attached to the digital image. The system includes generally at least a lens and a CCD unit. The lens is attached to a housing of the system, such as a camera. The storage device and the CPU are mounted within the housing. Further a grid beam light unit may be provided as either an internal or external unit.

### FIELD OF THE INVENTION

The present invention relates generally to capturing and processing of digital photographic images, and more particularly relates to a system and/or method of processing digital photographic images with distance information as depth channel.

### BACKGROUND OF THE INVENTION

Digital photography has been known and used for several years. Typically, the digital photography is composed of digital images of traditional photography. Conventional digital cameras capture light information of an image and breaks down the color information into three channels, that is, red, green and blue channels, i.e., RGB channels, to compose color images, and sometimes an additional black channel is used to enhance the background. However, this is two-dimensional based information.

The main problem with such conventional digital photography is that it is almost a digital copy of a traditional photography. Another problem with the conventional digital photography is that the information of digital images is of two dimensions, and the information of digital images is only about parameters of light. The other problem with the conventional digital photography is that retouching the digital images is still based on the normal drawing skills, that is, a kind of manual method rather than more advanced digital processing technique. Thus, it can be understood that the conventional digital photography does not take enough advantage of the new digital technology.

Whilst some digital technologies may be suitable for the particular purposes they did not address how a digital image can be processed with depth information to obtain a quasi-3D image. None of them is suitable for or taken into consideration of capturing depth information of an object and processing a digital image of the object with a depth channel in a two-dimensional digital photography. Up to now no one has ever proposed the use of such an additional depth channel in the electronic or digital image processing.

As mentioned above, the traditional retouching or modification of an electronic or digital image is still based on the conventional drawing technique, such as, brush erasing or modifying, etc. or in any event just changing the two dimensional parameters and color channels electronically. With a depth information and depth channel adopted in the digital image processing, the retouching or modification of an electronic or digital image photography becomes much easier and more digitized. For instance, changing the depth channel of a digital photographic image would result in smooth and natural alteration of photographic image so as to generate much better digital images.

Therefore, the present invention departs from the conventional concepts of producing and processing digital photography in the aforesaid respects. In addition to the information of two-dimensional images and color channels, the present invention captures the depth information of an object and processes such information for a depth channel being used in new digital photography. Such an depth channel can be used to enhance the quality of the digital photography, and to give more freedom in the image processing.

On the other hand, the distance information is used for regular cameras such as for focusing or for three-dimensional cameras to create a three-dimensional photography. For instance, U.S. Pat. No. 6,057,909 discloses an optical ranging camera with utilizing transmitting a light beams to get a reflected distance information for an object. The accuracy of the distance information of the reflected light beams for an image is limited, and such distance information is not intended or suitable to use in two-dimensional digital image processing. That is, the distance information in the existing technology is not organized as a whole, an independent image information group, such as a distance channel, and it is not seen as readable image information.

Thus, it is an object of the present invention to provide a system of digital photography that is capable of capturing depth information of an object and processing a digital photographic image with the depth channel.

It is another object of the present invention to provide a method of processing digital images in digital photography with distance information as depth channel.

It is a further object of the present invention to provide a system and/or method to create quasi-3D digital images with the processing of depth channel.

### SUMMARY OF THE INVENTION

According to the present invention, a system of capturing depth information of an object and processing a digital image with depth channel comprises means for receiving reflective and deflective light beams from the object, means for sensing the received light beams to generate digital images with distance information, means for storing the digital images, and a central processing unit for analyzing and processing the digital images.

The means for receiving the light beams includes at least a lens and a CCD array unit. The lens is attached to a housing of the system, such as a camera. The storage means and the CPU are mounted within the housing. Further, a grid beam light unit may be either an internal or external unit.

According to the present invention, a method of capturing depth information of an object and processing a digital image with depth channel comprises the steps of receiving reflective and deflective light beams from the object, detecting the light beams to generate digital images with distance information, storing the received distance information as depth channel for future processing, and analyzing and processing the digital image with the desired depth channel.

The method also comprises a step of transmitting light beams toward the object being detected to generate the reflective light beams in order to obtain distance information. The method further comprises a step of analyzing and recording the distance information as depth channel before storing the depth channel such that the distance information is treated as depth channel for use in the digital image processing. Still further, the method comprises a step of processing the digital image with the depth channel together with other two-dimensional channels and light channels.

In such a new digital photography construction, the distance information can be utilized to generate depth information, and treat it as a depth channel in the digital image processing in the digital photography. Therefore, the present invention may take advantage of three-dimensional photographic technology, i.e., processing digital images with distance information and creating quasi-3D digital images by using the distance information as depth channel.

This will add a three-dimensional structure for digital images, and in the digital images, a light effect can be easily changed as a three-dimensional structure.

The present invention may be embodied in the form illustrated in the accompanying drawings. However, the drawings are for illustrative purpose only. When considered in conjunction with the accompanying drawings, like reference characters designate the same or similar parts in all of the drawings and throughout the description of the invention.

### BRIEF DESCRIPTION OF THE DRAWINGS

FIG. 1 is an illustration of a new digital camera according to the present invention.

FIG. 2 shows a CCD unit used for the system of the present invention.

FIG. 3 is a flow chart showing how the apparatus of the present invention works.

### DESCRIPTION OF THE PREFERRED EMBODIMENT

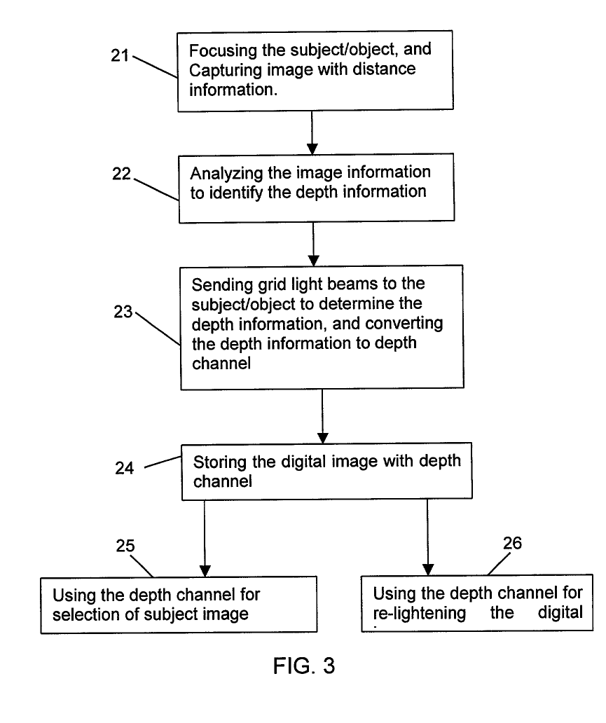

The primary concept of the present invention is to utilize the distance information obtained during the photo shooting, and to convert the distance information into depth information and to keep the depth information in depth channel for future digital image processing. There could be various use of such depth channel, such as selection of the subject being viewed and creation of better light effects to the image, etc. It is believed that prior to the present invention no one has ever mentioned such application of depth channel in the (2-dimensional) digital image processing so as to acquire quasi 3D-digital images. The operation of the present invention is illustrated in FIG. 3 and will be described hereinafter.

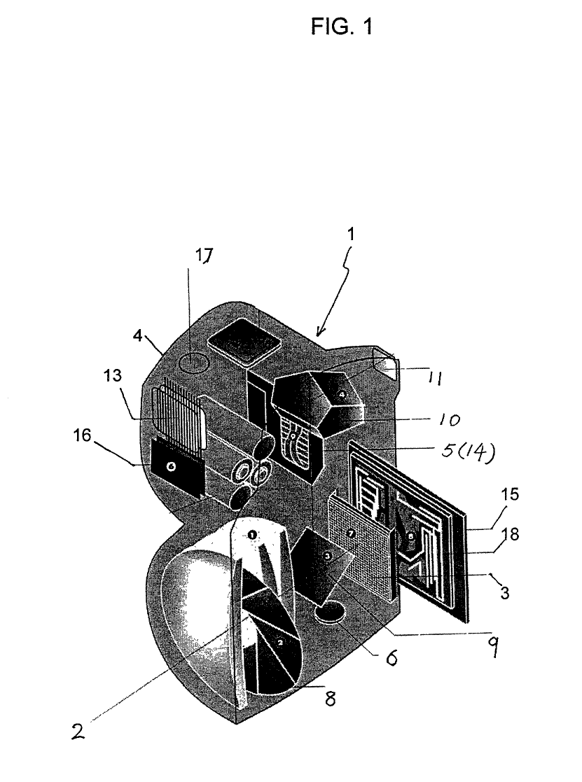

Turning now to FIG. 1, it illustrates how a new digital camera 1, apparatus or system can capture depth information for the depth channel, such that the camera of the present invention may comprise a depth channel for digital image processing in the digital photography.

The system of capturing depth information of an object and processing a digital image with a depth channel comprises means for receiving reflective and deflective light beams from the object. The means for receiving the light beams includes at least a lens 2 and a CCD array unit 3. Normally, it will contain a housing 4 or a main body of an apparatus that is a camera or the like. The lens 2 is attached to the housing of the system, such as a camera. The CCD array unit 3 is mounted inside the housing 4 of the camera 1, and also functions as means for sensing the received light beams to generate digital images with depth information.

A storage device 5 is means for storing the digital images, including all the information of RGB light channels, etc. and mounted inside the housing 4 of the system. A central processing unit (CPC) 6 is installed in the housing and used for analyzing and processing the digital images. Further, a grid beam light unit 7 may be either an internal or external unit. It can be an attachment to the outside of the housing if it is an external unit.

The light reflected from an image goes through the lens 2 and reaches the CCD unit 3. The CCD (charge-coupled device) unit 3 is normally arranged in a rectangular matrix. Each CCD is an array of microscopic elements, each one corresponding to a pixel in the final image. The light first passes through an infrared filter that prevents exaggerated red values. The next filter layer consists of a mosaic of red, green and blue that breaks down the color information into three channels.

The CCD unit 3 sends image information to the CPU 6, which processes the image information, and breaks them down into image color information, such as RGB color or grayscale information and image distance information. Then the CPU 6 saves the image into the storage device 5. The apparatus can be built in various ways, such as using two lenses and two CCD units for distance information calculation.

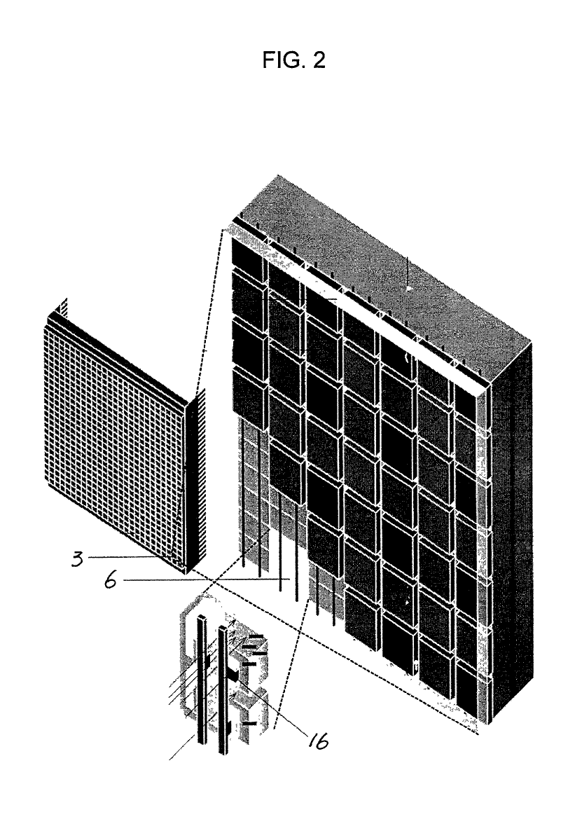

The FIG. 2 is an illustration of CCD unit in such a digital camera. When a user presses down partially on a shutter button 17, it triggers the automatic focus and exposure mechanism, adjusts the lens 2 and the iris aperture 8. In a reflex camera as shown in FIG. 1, the light entering the lens 2 is deflected by a mirror 9, through a prism 10, to a small viewing screen attached to an eyepiece 11. When the shutter button 17 is depressed completely, the mirror 9 flips out of the light path. Then, the infrared flash unit 13 is flashed, and the CCD matrix 3 is activated. A logic board 12 of the CPU 6 processes the CCD matrix readout. The logic board 12 processes color information of the image and saves them to red channel, green channel and blue channel.

One of the CCD matrixes 3 is for depth channel readout, and the infrared flash signals reflect back from the subjects of the image. The timing of the signals that reflect back from the subjects is different because the distance of each point of the subjects is different. The CCD 3 collects and then sends the information to the logic board 12. The logic board 12 processes the information and converts the timing information of the signals to the depth information of the image, and saves them to the depth channel. The processed image is sent to the memory card 14 for storage, and to the LCD image display 15. After a few seconds the camera is ready for the next picture.

A channel in a digital image contains all of the information of the image. A depth channel contains all of the depth information of a digital image. As seen above, the CCD unit 3 may include an infrared sensor 16 to collect the depth information of the each pixel into the depth channel. The depth information of a pixel can be determined by the distance from a point of the subject or object to the plane of the CCD array unit 3 in the digital camera.

The depth information can be captured in many different ways. For example, the camera can capture the infrared light, which is sent by the camera and reflected back by the subject, which contains depth information of the image, and then store the information into the depth channel. The depth channel may add the third dimensional information to a digital image and thus such digital image contains three-dimensional structure information.

A subject of such a digital image with a depth channel could be selected by depth. For example a model stands about 5 feet from the camera and thus the digital image thereof with depth information may proceed with a depth channel. Then, a user could select the subject from 4.5 feet to 5.5 feet. The model would be selected in a few seconds with every piece of her single hair. In such a digital image, the depth information and depth channel will make the digital photography more functional.

The grid beam light unit 7 may send horizontal and vertical beam light. The horizontal and vertical light beams cross with one another as a grid. The light beam may be laser beam or the like, which sends a grid beam light to a subject, including horizontal and vertical beams of the grid. The distance is the same between each of the crossed horizontal and vertical lines. Such beam light is shown as a grid on the surfaces of the subject. The grid is a reference for the three-dimensional surface mapping and distance measurement, since the beams on the surface of the subject would follow the surface of the subject as a surface map, and the distance between the beams of the light is greater when the distance is farther from the apparatus. The grid beam light can use laser technology or any other technology so long as it can provide clean, powerful beam lines.

In any event, the system of the present invention may capture the distance information and transfer it into depth channel, and then process the original two-dimensional digital image with the depth channel so as to obtain quasi three-dimensional digital image.

The operation of the system is described with reference to FIG. 3. When a user slightly presses the shutter release button, the apparatus starts scanning and focusing the image of the subject, indicated at 21. The lens starts to move from infinity to the nearest focus point and the CCD unit 3 starts to capture continuously the image information and send the information to the CPU 6 that is the image-processing center. The CPU 6 analyzes, indicated at 22, the image information from each CCD, and the change of each part of the image information when the lens moves from the infinity to the nearest subject in the image.

The part of the image gets the most contrast when it is in the focus point. This point is the distance from the lens of the apparatus to the point of the image. At the same time, the grid beam light unit 7 sends out, at 23, horizontal and vertical beam light to the subject. In the digital photography, an image is captured and stored, at 24, as a group of pixels. Each pixel is stored in an area of memory called a bit-map. Each pixel has a numbered address. In every addressed pixel, it has more information about the brightness level of the image in that spot. In a RGB color image, each pixel is assigned with separate brightness values for red, green, and blue. An image component that contains the pixel information for an individual color is called a channel. Likewise, the present inventor proposes that an image component that contains the depth information of the subject is used as a depth channel. A grayscale image has a color channel, a RGB image has three-color channels, and a CMYK image has four-color channels. A distance or depth channel is an additional channel, that stores distance information for digital photos. The distance information in the depth channel or distance channel can be used for image processing and image manipulating.

A distance channel has many advantages for digital photography. For example, the distance information in a distance or depth channel will make, indicated at 25, selection of subjects much easier, especially the selection of the complicated subjects from complex backgrounds. In the new digital image-editing program using the depth channel, it can select the subjects by the distance information. The program will select the entire subject in the distance arrangement when a user types in a distance value. The selection could be done by just few clicks even for a very complicated subject. The program can recognize and render, indicated at 26, a 3D-structure for a 2D-digital image by the distance information in the depth channel. Once defined as a quasi-3D environment, any lightening source or light effect in the image can be changed as easy as real life re-lightening. When a user changes position of any light element in the program, the shape and the depth of the object's shades will change accordingly.

A user may also pick any light effect from the computer database, and the program will produce the desired light effects in connection with the depth channel such that the modified light effect can be as close as the real life lightening. This simplification will save valuable amount of time and money to create new digital photography with new lightening in various consumer and commercial fields.

In sum, according to the present invention, the depth information can be captured in many different ways. It can be captured as passive signal that comes from subjects in the range of camera. It can also be captured as an active signal that is sent by a digital camera and reflected back from the subjects. Further, a 3D-cameral can capture such depth information. The 3D-camera has two lenses and two CCD units. The camera gets the image information from the two CCD units through two different lenses, and then the logic board of the CPU calculates the two sets of information and recreates the depth information of the subject for the depth channel. Then, the storage device keeps the final image information with the RGB channels and the depth channel. The digital cameras that can capture depth information vary in configuration, but their basic operation of capturing and processing depth channel is similar.

The depth channel can work in many different modes of digital images, such as Bitmap, Duotone, Index color, RGB color, CMYK color, Lab color . . . etc. The depth channel can also work in different formats, such as JPEG, PCX, PDF, PSD, TIFF . . . etc. The new digital photography technology of the present invention not only works for still photography, but also works with moving photography, such as video.

The scope of the present invention is defined in the accompanying claims. However, it can be understood that the optimum dimensional relationship for the parts, including variations in size, materials, shape, etc. may be apparent and obvious to one skilled in the art, and thus all equivalents to those described and illustrated in the description and drawings are within the scope of the present invention.

What is claimed is:

1. A system of capturing and processing a digital image with distance information, comprising means for receiving reflective and deflective light beams from an object, means for sensing the received light beams to generate digital images with distance information, means for storing the digital images, and a central processing unit for analyzing and processing the digital image of distance information by using the distance information as a depth channel.

2. The system of claim 1, wherein the means for receiving the light beams includes at least a lens and a CCD array unit, and the lens is attached to a housing of the system.

3. The system of claim 2, wherein the storage means and the CPU are mounted within the housing.

4. The system of claim 2, further comprising a grid beam light unit being provided as an internal unit inside the housing.

5. The system of claim 2, further comprising a grid beam light unit being provided as an external unit.

6. A method of capturing and processing a digital image with distance information, comprising the steps of receiving reflective and deflective light beams from an object, detecting the light beams to generate digital images with distance information, converting the distance information into depth channel, storing the digital image with said depth information for future processing, and analyzing and processing the digital image with the desired depth channel.

7. The method of claim 6, wherein said step of processing includes adjusting said depth channel at a desired pixel of said digital image.

8. The method of claim 6, further comprising a step of transmitting grid light beams toward the object, including horizontal and vertical beam light to generate a digital image of a group of pixels carrying depth information.

9. The method of claim 8, wherein the step of analyzing the distance information comprises the analysis of received grid light beams so as to determine depth information of the digital image.

10. The method of claim 6, further comprising storing said depth channel as a group of information independent from other light channels of red, green, and blue.
